(19) United States
(12) Patent Application Publication
(10) Pub. No.: US 2026/0288334 A1
(43) Pub. Date: Sep. 24, 2026

(54) ARTIFICIAL INTELLIGENCE ENGINE (AIE) ARRAY WITH A MEMORY TILE BETWEEN AIE TILES

(71) Applicant: XILINX, INC., San Jose, CA (US)

(72) Inventors: Juan J. NOGUERA SERRA, San Jose, CA (US); David Patrick CLARKE, Dublin (IE)

(21) Appl. No.: 19/088,639

(22) Filed: Mar. 24, 2025

(51) Int. Cl. G06F 3/06

(52) U.S. Cl. CPC G06F 3/061; G06F 3/0655; G06F 3/0679

(57) ABSTRACT

An integrated circuit device that includes a memory circuit having a memory bank, a first input/output (IO) interface along a first edge of the memory circuit to permit access to the memory bank, a second IO interface along a second edge of the memory circuit to permit access to the memory bank, and synchronization circuitry to manage access to the memory bank via the first and second IO interfaces. The first and second edges may be opposite one another or adjacent to one another. The IC device may further include a first set of data processing elements (DPEs) that access the memory bank via the first IO interface, and a second set of DPEs that access the memory bank via the second IO interface. One or more of the DPEs may include an artificial intelligence engine (AIE).

### TECHNICAL FIELD

Examples of the present disclosure generally relate to an artificial intelligence engine (AIE) array with a memory tile between AIE tiles.

### BACKGROUND

Bandwidth between a memory circuit and multiple data processing elements (DPEs), such as artificial intelligence engines (AIEs), may be limited due to physical wiring/layout constraints.

### SUMMARY

Techniques for an artificial intelligence engine (AIE) array with a memory tile between AIE tiles are described. One example is a memory circuit that includes a memory bank, a first input/output (IO) interface along a first edge of the memory circuit to permit access to the memory bank, a second IO interface along a second edge of the memory circuit to permit access to the memory bank, and synchronization circuitry that manages access to the memory bank via the first and second IO interfaces.

Another example described herein is an IC device having a data processing array that includes a memory circuit having a memory bank, a first input/output (IO) interface along a first edge of the memory circuit, a second IO interface along a second edge of the memory circuit, and synchronization circuitry that manages access to the memory bank via the first and second IO interfaces. The data processing array further includes a first set of data processing elements (DPEs) that access the memory bank via the first IO interface, and a second set of DPEs that access the memory bank via the second IO interface.

Another example described herein is graphics processing unit (GPU) that includes a GPU core and a data processing array that perform tasks for the GPU core, where the data processing array includes a memory circuit having a memory bank, a first input/output (IO) interface along a first edge of the memory circuit, a second IO interface along a second edge of the memory circuit, and synchronization circuitry that manages access to the memory bank via the first and second IO interfaces. The data processing array further includes a first set of data processing elements (DPEs) that access the memory bank via the first IO interface, and a second set of DPEs that access the memory bank via the second IO interface.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts an integrated circuit (IC) device that includes a memory circuit and data processing elements (DPEs), according to an embodiment.

FIG. 2 depicts the IC device of FIG. 1, according to another embodiment.

FIG. 3 depicts the IC device of FIG. 1, according to another embodiment.

FIG. 4 depicts the IC device of FIG. 1, according to another embodiment.

FIG. 5 depicts the IC device of FIG. 1, in which the memory circuit and the DPEs are part of an array, according to another embodiment.

FIG. 6 depicts a portion of the array of FIG. 5, according to an embodiment.

FIG. 7 depicts a DPE, according to an embodiment.

FIG. 8 depicts a DPE, according to another embodiment.

FIG. 9 depicts the memory circuit, according to an embodiment.

FIG. 10 depicts a system in which the array of FIG. 5 is integrated as part of a graphics processing unit (GPU), according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe artificial intelligence engine (AIE) tiles interspersed with memory tiles.

An integrated circuit device may include a memory circuit that is accessible to multiple data processing elements (DPEs) via an input/output interface (e.g., electrical connections/pads) along an edge of the memory circuit. Bandwidth between the memory circuit and the DPEs may be limited due to physical constraints. For example, physical spacing requirements associated with the electrical contacts/pads and/or with metal traces between the electrical contacts/pads and the DPEs may limit the number of DPEs that can access the memory circuit, and may impact routing options of the IC device.

As disclosed herein, a memory circuit may include multiple interfaces along multiple respective edges of the memory circuit (i.e., beachfronts). The memory circuit may be physically placed between multiple sets of DPEs. The multiple sets of DPEs may be physically placed opposite respective edges of the memory circuit, and may access the memory circuit via the respective interfaces. The multiple interfaces may permit an increased number of DPEs to access the memory circuit, and/or may reduce congestion. In other words, more surface area along a perimeter of the memory circuit is used for IO interfacing, to permit more wires/connections, which increases bandwidth.

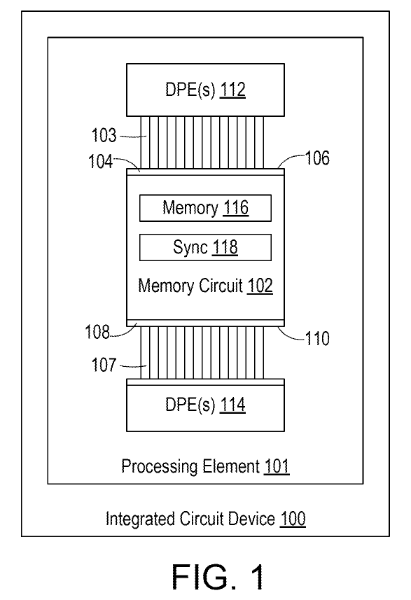

FIG. 1 depicts an integrated circuit (IC) device 100, according to an embodiment. IC device 100 may include one or more IC dies and/or a printed circuit board. In the example of FIG. 1, IC device 100 includes a processing element 101 that includes a memory circuit 102, a first set of one or more data processing elements (DPEs) 112, and a second set of one or more DPEs 114.

Memory circuit 102 includes a first IO interface 104 along a first edge 106, and a second IO interface 108 along a second edge 110. Edges 106 and 108 may be opposite one another, as depicted in FIG. 1, or may be adjacent to one another. IO interfaces 104 and 108 may include respective input/output (IO) electrical contacts/pads. DPE(s) 112 access memory circuit 102 via interconnects 103 and IO interface 104. DPE(s) 114 access memory circuit 102 via interconnects 107 and IO interface 108.

Memory circuit 102 includes memory 116, such as random-access memory (RAM). Memory circuit 102 may further include synchronization circuitry 118 that manages access to memory 116 by DPE(s) 112 and 114.

DPEs 112 and 114 may be physically placed adjacent to, or facing edges 106 and 110, respectively. Providing separate IO interfaces 104 and 108 (i.e., beachfronts) for DPE(s) 112 and 114 along respective edges 106 and 110, and placing DPE(s) 112 and 114 adjacent to, or facing respective edges 106 and 110, may be useful to simplify/reduce wiring congestion, increase wiring options, and improve bandwidth between DPEs 112 and memory circuit 102, and between DPEs 114 and memory circuit 102.

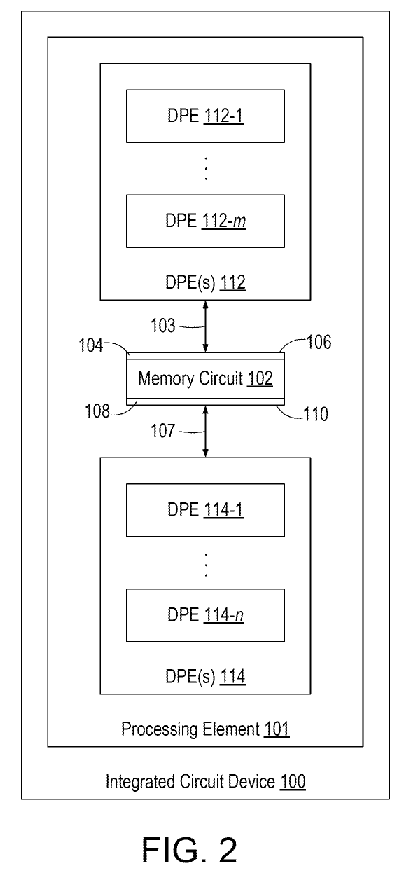

FIG. 2 depicts IC device 100, according to another embodiment. In the example of FIG. 2, DPE(s) 112 include DPEs 112-1 through 112-m, and DPE(s) 114 include DPEs 114-1 through 114-n.

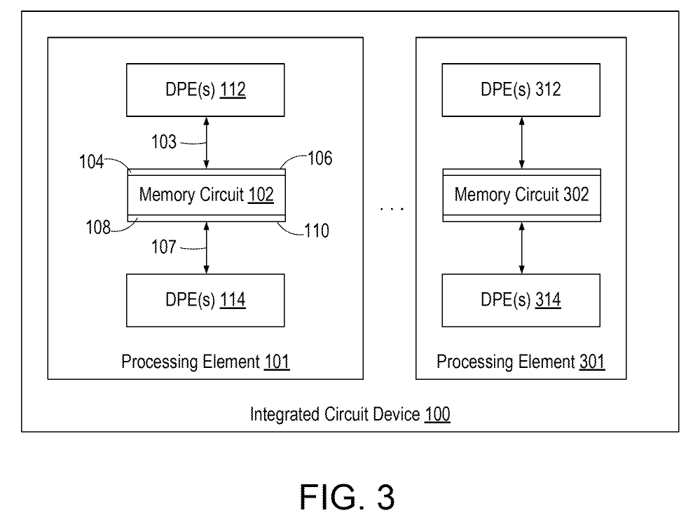

FIG. 3 depicts IC device 100, according to an embodiment. In the example of FIG. 3, IC device includes one or more additional processing elements, depicted here as a processing element 301 that includes a memory circuit 302, a first set of one or more DPE(s) 312 and a second set of one or more DPE(s) 314.

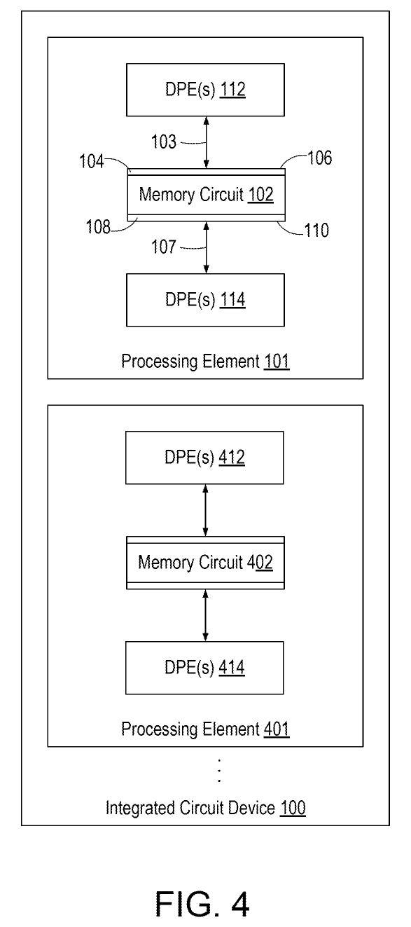

FIG. 4 depicts IC device 100, according to another embodiment. In the example of FIG. 4, IC device includes a column of multiple processing elements, including processing element 101 and a processing element 401. Processing element 401 includes a memory circuit 402, a first set of one or more DPE(s) 412 and a second set of one or more DPE(s) 414.

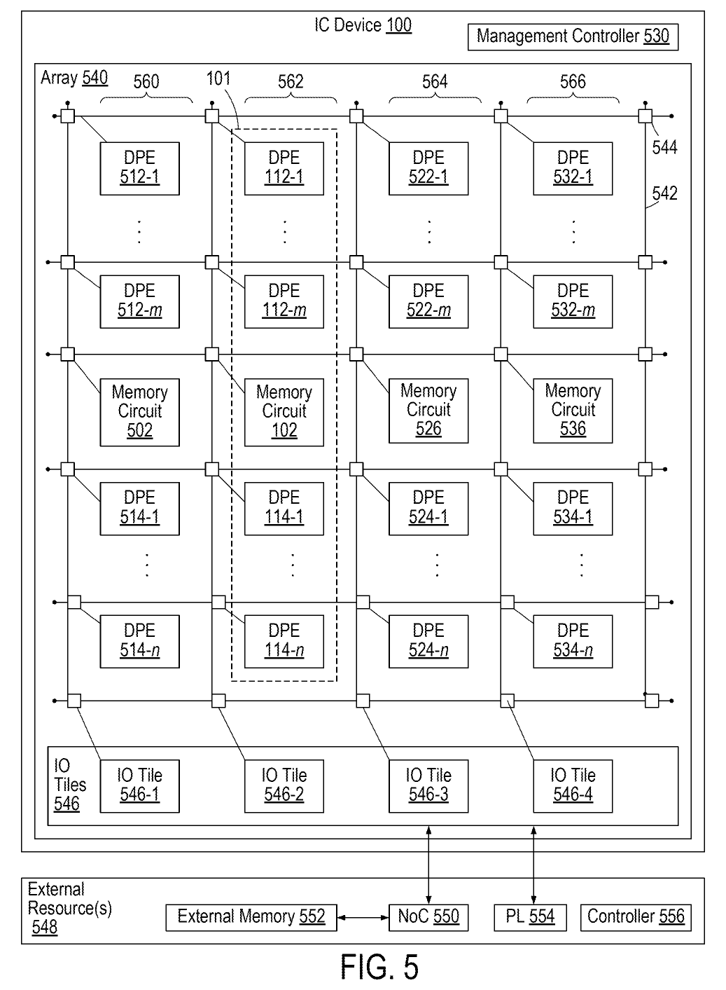

FIG. 5 depicts IC device 100, according to another embodiment. In the example of FIG. 5, IC device 100 includes an array 540 that includes columns 560 through 566 of processing elements, and an interconnect network that includes links 542 and switches 544. Switches 544 may be configurable, and may be incorporated within processing elements of array 540, examples of which are provided further below. Array 540 may include fewer than four columns of processing elements or more than four columns of processing elements.

Column 560 includes DPEs 512-1 through 512-m, a memory circuit 502, and DPEs 514-1 through 514-n. Column 562 includes processing element 101. Processing element 564 includes DPEs 522-1 through 522-m, a memory circuit 526, and DPEs 524-1 through 524-n. Column 566 includes DPEs 532-1 through 532-m, a memory circuit 536, and DPEs 534-1 through 534-n.

In FIG. 5, IC device 100 further includes input/output (IO) tiles 546 that interface between DPEs and/or memory circuits of array 540, and external resource(s) 548. External resource(s) 548 may include a packet-based network-on-chip (NoC) 550, external memory 552, programmable logic 554, and/or a controller 556.

IC device 100 may further include a management controller 350 to manage features of array 540, such as to provide configuration bits, which are described further below.

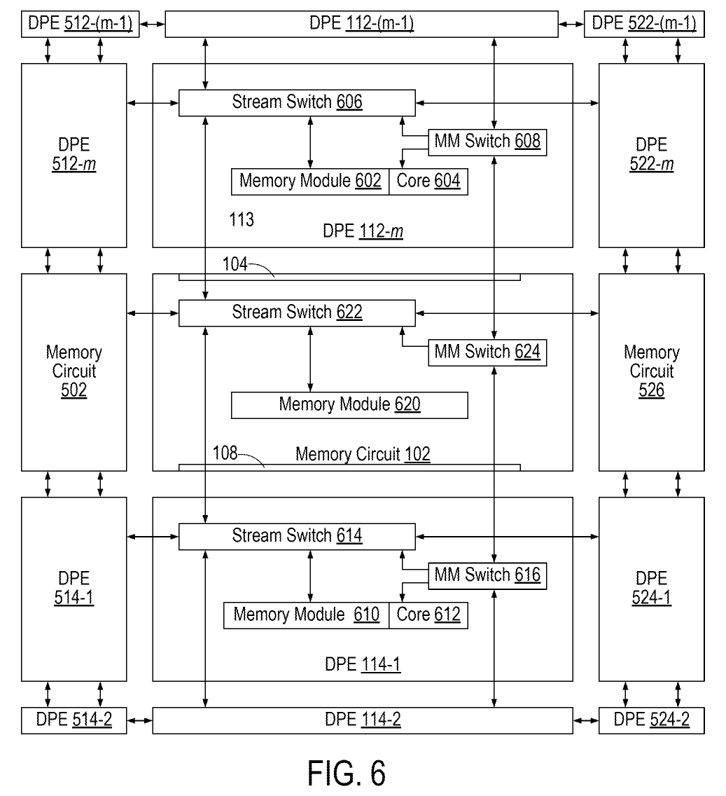

FIG. 6 depicts a portion of array 540, according to an embodiment. In the example of FIG. 6, Memory circuit 102 includes a memory module 620, a stream switch 622, and a memory mapped (MM) switch 624. DPE 112-m includes a memory module 602, a core 604, a stream switch 606, and a memory mapped (MM) switch 608. DPE 114-1 includes a memory module 610, a core 612, a stream switch 614, and a MM switch 616.

Stream switches 622, 606, and 614 and associated interconnects may form a data streaming network. Stream switches 606 may be configurable/programmable to establish connections amongst selected DPEs and/or memory circuits. Stream switches 606 may be configurable/programmable to form clusters of DPEs and memory circuits that can exchange data, such as application data generated and/or operated on during runtime. Stream switches 622, 606, and 614 may be configurable to operate as a circuit-switching stream interconnect or a packet-switched stream interconnect. A circuit-switching stream interconnect may serve as a point-to-point communication channel, which may be dedicated to high-bandwidth communications amongst DPEs. A packet-switching stream interconnect may serve as a shared (e.g., time-multiplexed) communication channel for medium-bandwidth data streams.

In FIG. 6, stream switch 622 provides communications amongst elements of memory circuit 102. Stream switch 622 may also provide communications between memory circuit 102 and DPE 112-m via first IO interface 104. Stream switch 622 may also provide communications between memory circuit 102 and DPE 114-1 via IO interface 108. Stream switch 622 may also provide communications between memory circuit 102 and adjacent memory circuits 502 and 526.

MM switches 608 may form a memory-mapped network in which MM switches 608 dynamically route transactions based on addresses. The memory-mapped network may also be referred to as a transaction-switched network. The memory-mapped network may be used to communicate data, commands, and/or bits for configuration, control, and/or debugging. The memory mapped network may have access to all storage elements (e.g., memory, registers, latches, and/or other storage elements) of array 540, or a subset thereof. MM switches 608 may permit other circuits/devices to access resources of array 540. In an example, array 540 is mapped to an address space of management controller 530, to permit management controller 530 to access storage elements of DPEs and/or memory circuits. Management controller 530 may use the memory-mapped network to provide configuration bits, such as described below.

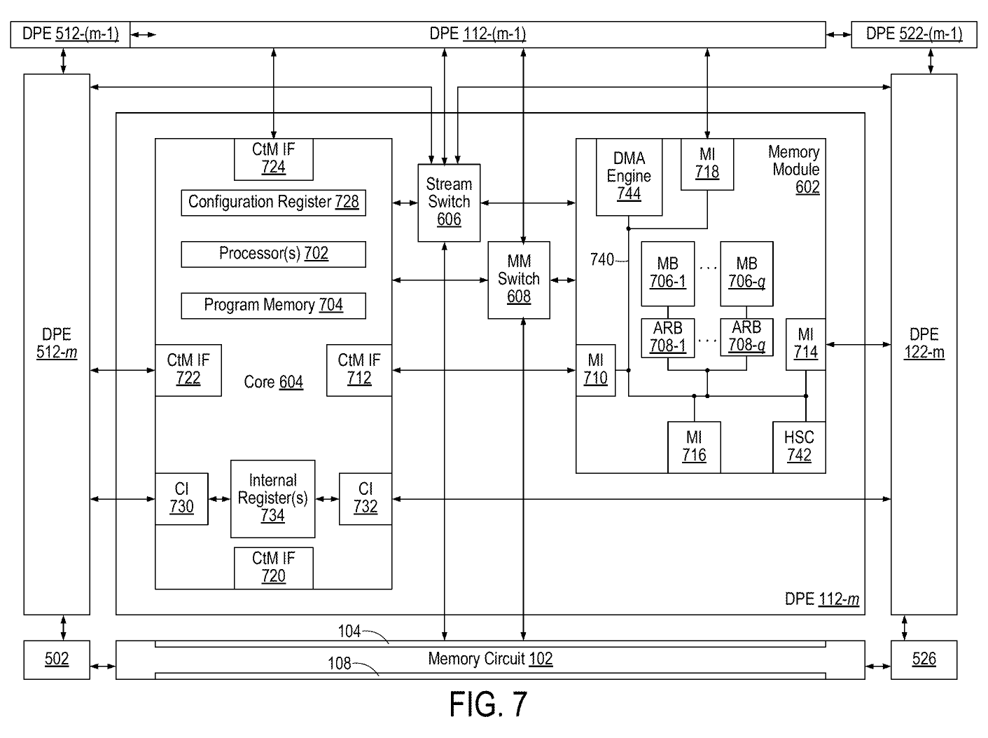

FIG. 7 depicts a portion of array 540, according to another embodiment. In the example of FIG. 7, core 604 of DPE 112-m includes an instruction processor(s) 702, and program memory 704 that stores instructions for execution by processor(s) 702. The instructions may be provided by management controller 530. Processor(s) 702 may include, for example and without imitation, a central processing unit (CPU,) a graphics processing unit (GPU), a digital signal processor (DSP), a vector processor, a very long instruction word (VLIW) vector processor, and/or other type(s) of processor(s). Alternatively, or additionally, one or more DPEs may be implemented with hardware-based logic (e.g., combinational logic and/or sequential logic). Alternatively, or additionally, one or more processor(s) 702 may include customized architecture to support an application-specific instruction set.

Core 604 may include one or more cascade interfaces (CIs) that provide direct communications with adjacent DPEs. In the example of FIG. 7, core 604 includes CIs 730 and 732 that interface with DPEs 512-m2 and 122-m. In an example, CI 730 serves as an input CI, and CI 732 serves as an output CI. In this example, CI 730 may receive an input data stream from DPE 512-m, and may provide the data stream to processor(s) 702 and/or to CI 732, which may forward the data stream to DPE 122-m. CIs 730 and 732 may convey multi-bit data streams (e.g., tens or hundreds of bits in width). CIs 730 and 732 may include first-in-first-out (FIFO) buffers. CIs 730 and 732 may be controlled by processor(s) 702. In an example, processor(s) 702 may execute instructions to read from and/or write to CI 730 and/or CI 732. Alternatively, or additionally, core 604 may include hardwired logic to read from and/or write to CI 730 and/or CI 732. Alternatively, or additionally, CI 730 and/or CI 732 may be controlled by management controller 530 and/or another device.

Core 604 may further include an internal register(s) 734. Internal register(s) 734 may store data received via CI 730, and/or data generated and/or operated on by processor(s) 702. Internal register(s) 734 may include an accumulation register that stores intermediate results of operations performed by processor(s) 702. An accumulation register may be useful to free processor(s) 702 from writing intermediate results to MBs 706 and/or other memory, which may save time and/or resources. Internal register(s) 734 may further include an additional register(s) that receives data via CI 730. In this example, CI 730 may write the received data to the accumulation register and/or may output the received data via CI 732 in a cascaded fashion. CIs 730 and 732 may transfer data on each clock cycle. CIs 730 and 732 may cascade internal register(s) 734 with internal register(s) of other DPEs.

Core 604 may further include a core-to-memory (CtM) interface 712 to permit core 604 to access memory module 602. Core 604 may further include CtM interfaces 720, 722, and 724, to access memory modules of adjacent DPEs. Where DPE 112-m is placed opposite memory circuit 102, as depicted in FIG. 7, CtM interface 720 may be unused. Core 604 may map/route read and/or write operations through CtM interface 712, CtM interface 720, CtM interface 722, CtM interface 724, CI 730, and/or CI 732, based on addresses of the respective operations. Core 604 may decode addresses of received data to determine forwarding destinations of the received data, and/or may assign addresses to data generated by core 604 based on intended destinations of the generated data.

Core 604 may further include configuration memory, depicted here as configuration registers 728, which management controller 530 may load with configuration bits (e.g., via MM switch 608) to control operation of DPE 112-m. Configuration registers 728 may be addressable via the memory mapped network of MM switches. Configuration registers 728 may control, for example and without limitation, configuration of core 604, configuration of memory module 602, configuration of stream switch 606, configuration of CtM interfaces 712, 720, 722, and 724, and/or configuration of CIs 730 and 732. Examples are provided below.

Configuration registers 728 may determine whether CIs 730 and 732 are enable or disabled. Configuration registers 728 may enable selected ports of stream switch 606, and/or may configure stream switch 606 for packet-switched operation or circuit-switched operation. Configuration registers 728 may enable or disable DPE 112-m, or portions thereof. Configuration registers 728 may enable or disable memory module 602. In an example, configuration registers 728 disable core 604 and enable memory module 602, such that memory module 602is accessible to one or more other DPEs.

In the example of FIG. 7, memory module 702-6 includes one or more banks of memory and associated arbitration logic, depicted here as memory banks (MBs) 706-1 through 706-q, and arbitration logic (ARB) 708-1 through 708-q. ARBs 708 may include crossbars to permit writing to selectable MBs 706.

Memory module 602 further includes a memory interface (MI) 710 that permits core 604 to access MBs 706 via CtM interface 712. Memory module 602 may further include MIs 714, 716, and 718 to permit cores of adjacent DPEs to access MBs 706. Where DPE 112-m is placed opposite memory circuit 102, as depicted in FIG. 7, MI 716 may be unused.

Memory module 602 may further include a stream interface (not shown) that interfaces with stream switch 606, to permit other DPEs (e.g., non-adjacent DPEs) of array 540 to access MBs 706, via stream switch 606.

Memory module 602 may further include a DMA engine 744. DMA engine 744 may include one or more interfaces to receive data streams from other DPEs and/or memory circuit 102, write the received data to MBs 706, read data from MBs 706, and/or send data to other DPEs and/or memory circuit 102, via stream switch 606.

Memory module 602 may further include a memory mapped interface (not shown) that interfaces with MM switch 608.

Memory module 602 may further include a communication network 740 to provide communications amongst elements/components of memory module 602.

Memory module 602 may further include hardware synchronization circuitry (HSC) 742 that synchronizes operations of elements/circuits that have access to memory module 602 (e.g., core 604, cores of other DPEs, DMA engine 744, memory circuit 102, management controller 530, and/or other circuits/devices).

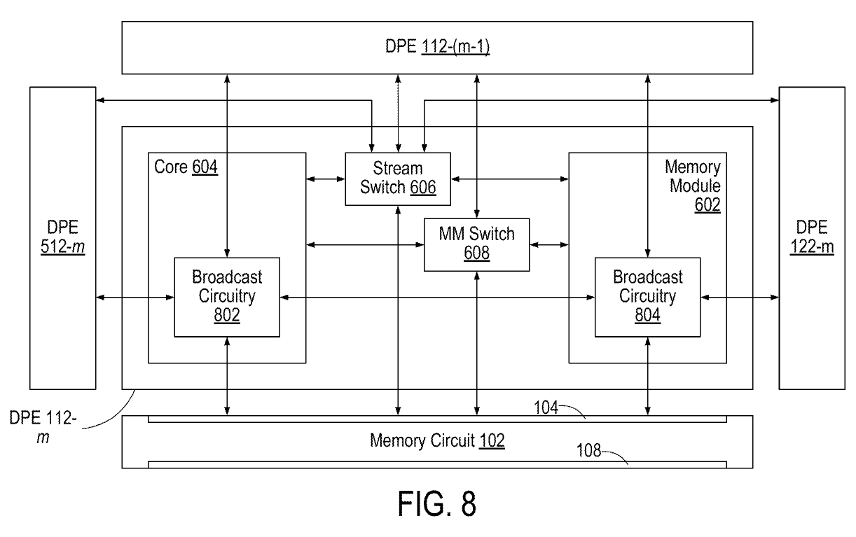

One or more DPEs may further include broadcast circuitry, such as described below with reference to FIG. 8. FIG. 8 depicts DPE 112-m and adjacent DPEs of array 540, according to a further embodiment.

In the example of FIG. 8, core 604 includes broadcast circuitry 802, and memory module 602 includes broadcast circuitry 804. In other examples broadcast circuitry 802 or broadcast circuitry 804 may be omitted. Broadcast circuitry 802 and/or broadcast circuitry 804 may be connected to broadcast circuitry of other DPEs and/or memory circuit 102, such as depicted in FIG. 8. Broadcast circuitry of DPEs and memory circuit 102 may form a broadcast network, which may be independent of other communication channels of IC device 100. Broadcast circuitry 802 and/or broadcast circuitry 804 may be combined with one or more features described in other examples herein.

Broadcast circuitry of the DPEs and/or memory circuit 102 may be individually configurable based on configuration bits stored in control registers of the respective DPEs and/or memory circuit 102. Broadcast circuitry 802 and/or broadcast circuitry 804 may, for example, be configurable to detect specified types of events that occur within core 604 and/or memory module 702-6. Detectable events within core 604 may include, without limitation, starts and/or ends of read operations by core 604, starts and/or ends of write operations by core 604, stalls, and/or other operations performed of core 604. Detectable events within memory module 602 may include, without limitation, starts and/or ends of read operations of DMA engine 744, starts and/or ends of write operations by DMA engine 744, stalls, and other operations of memory module 602. In other examples, broadcast circuitry 802 and/or broadcast circuitry 804 may detect specified types of events that occur within and/or in relation to DMA engine 744, MM switch 608, stream switch 606, MI 710, MI 714, CtM interface 712, CtM interface 722, CI 730, CI 732, and/or other components of DPE 112-m. Configuration registers 728 of DPE 112-m may control which events generated by DPE 112-m and/or which events received by broadcast circuitry 802 and/or 804, are propagated to broadcast circuitry of other DPEs and/or memory circuit 102. Configuration registers 728 may control which events are propagated between broadcast circuitry 802 and broadcast circuitry 804. In an example, broadcast circuitry 802 generates events based on conditions within core 604, and broadcast circuitry 804 generates events based on conditions within memory module 602. After configuration bits are written to configuration registers 828 (i.e., via MM switch 608), broadcast circuitry 802 and/or 804 may operate in a background fashion.

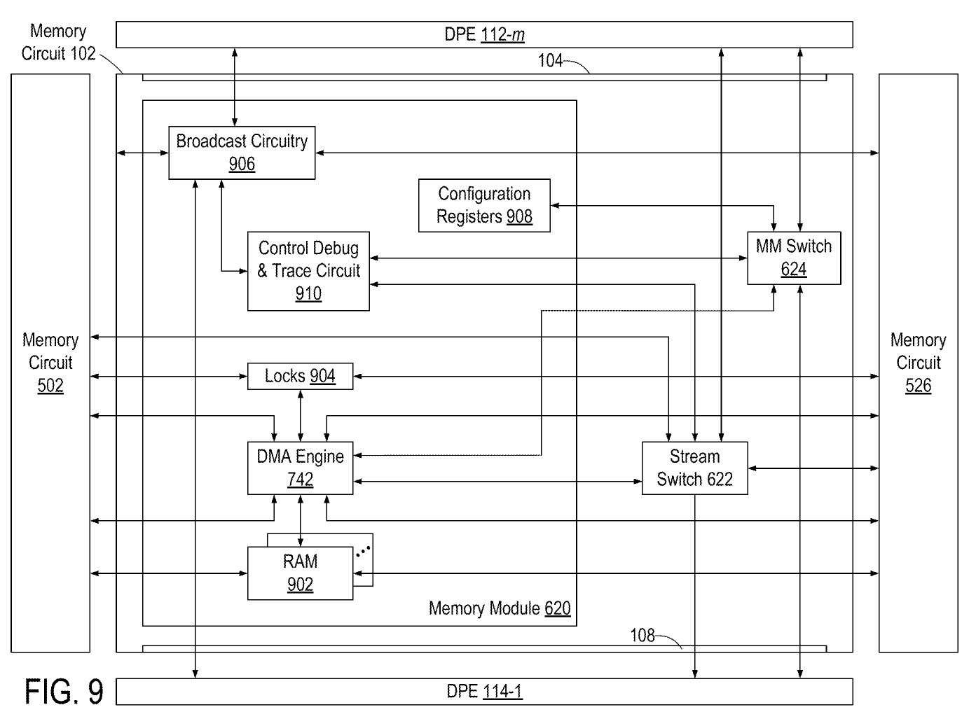

FIG. 9 depicts memory circuit 102, according to an embodiment. In the example of FIG. 9, memory module 620 includes random-access memory (RAM) 902. RAM 902 may be directly accessible via DMA engines of adjacent DPEs and/or memory circuits. RAM 902 may also accessible to other (e.g., non-adjacent) DPEs and/or memory circuits via stream switch 622 and DMA engine 742. Similarly, DMA engine 742 may directly access memory of adjacent DPEs and/or adjacent memory circuits.

Memory module 620 further includes synchronization circuitry, depicted here as locks 904, that synchronize access requests directed to RAM 902 from DMA engine 742. In an example, and without limitation, locks 904 may provide 64semaphore locks and a 6-bit state per lock. Locks 904 may be accessible to DMA engine 742, and may be further accessible to DMA engines of adjacent DPEs and/or adjacent memory circuits.

Memory module 620 may further include broadcast circuitry 906, which may operate as described further above with respect to broadcast circuitry 802 and/or 804 in FIG. 8. Broadcast circuitry 906 may generate events based on operations performed by memory circuit 102. Examples include, without limitation, start and/or completion of a read and/or write operation by DMA engine 742, and start and/or completion of a transaction conducted by stream switch 622. Broadcast circuitry 906 may detect selectable events within memory circuit 102 to forward the detected events to other broadcast circuitry and/or to a command, debug, and trace (CDT) circuit 910.

CDT circuit 910 may perform control, debug, and/or trace operations within memory circuit 102. During a debug operation, registers of memory circuit 102 may be mapped onto a memory map accessible via MM switch 624. CDT circuit 910 may include trace hardware, trace buffers, performance counters, and/or stall logic. The trace hardware may collect trace data. The trace buffers may buffer the trace data. CDT circuit 910 may output the trace data via stream switch 622. CDT circuit 910 may packetize event data received from broadcast circuitry 906, and may forward the packetized event data to stream switch 622. CDT circuit 910 may also packetize the trace

Memory module 620 may further include configuration registers 908 that receive configuration bits via MM switch 624. Configuration bits loaded in configuration registers 908 determine operation of memory circuit 102. The configuration bits may, for example, determine which events are generated by broadcast circuitry 906 and/or which events are passed on to other destinations. The configuration bits may determine logical connections established by stream switch 622. The configuration bits may control access to RAM 902. The configuration bits may determine debug and trace modes of CDT circuit 910.

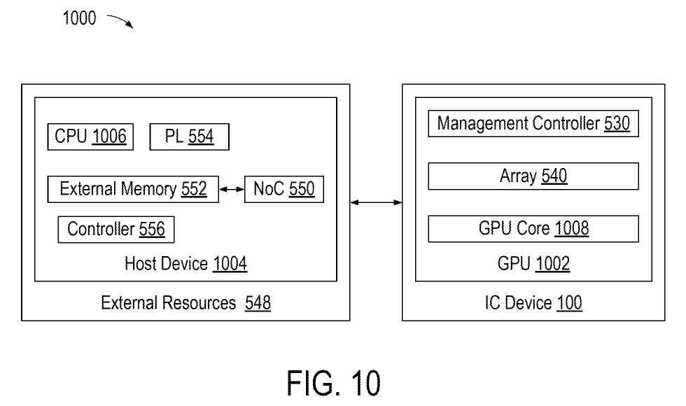

FIG. 10 depicts a system 1000 in which array 540 is integrated as part of a graphics processing unit (GPU) 1002, according to an embodiment. In the example of FIG. 10, a host device 1004, having a central processing unit (CPU) 1006, offloads tasks to GPU 1002. A GPU core 1008 may assign tasks to array 540 for execution by DPEs therein.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit (IC) device, comprising:
a memory circuit comprising:
a memory bank;
a first input/output (IO) interface along a first edge of the memory circuit, configured to permit access to the memory bank;
a second IO interface along a second edge of the memory circuit, configured to permit access to the memory bank; and
synchronization circuitry configured to manage access to the memory bank via the first and second IO interfaces.

2. The IC device of claim 1, wherein the first and second edges are opposite one another.

3. The IC device of claim 1, wherein the first and second edges are adjacent to one another.

4. The IC device of claim 1, further comprising:
a first data processing element (DPE) configured to access the memory bank via the first IO interface; and
a second DPE configured to access the memory bank via the second IO interface;
wherein the synchronization circuitry is further configured to manage access to the memory bank by the first and second DPEs.

5. The IC device of claim 4, wherein:
the first DPE is physically placed opposite the first edge of the memory circuit; and
the second DPE is physically placed opposite the second edge of the memory circuit.

6. The IC device of claim 4, further comprising a data streaming network, wherein:
the first DPE comprises a first core, a first memory module, and a first stream switch of the data streaming network coupled to the first core and the first memory module;
the second DPE comprises a second core, a second memory module, and a second stream switch of the data streaming network coupled to the second core and the second memory module;
the first and second cores each comprise a processor and program memory configured to store instructions for execution by the processor; and
the memory circuit further comprises a third stream switch of the data streaming network configured to interface with the first stream switch via the first IO interface of the memory circuit, and to interface with the second stream switch via the second IO interface of the memory circuit.

7. The IC device of claim 6, wherein:
the first stream switch is configured to interface amongst the first core, the first memory module, and the memory circuit; and
the second stream switch is configured to interface amongst the second core, the second memory module, and the memory circuit.

8. The IC device of claim 4, further comprising a memory-mapped network, wherein:
the first DPE comprises a memory-mapped switch of the memory-mapped network configured to receive a first set of configuration bits, and a first set of configuration registers configured to store the first set of configuration bits;
the second DPE comprises a second memory-mapped switch of the memory-mapped network configured to receive a second set of configuration bits, and a second set of configuration registers configured to store the second set of configuration bits;
the memory circuit comprises a third memory-mapped switch of the memory-mapped network configured to receive a third set of configuration bits, and a third set of configuration registers configured to store the third set of configuration bits; and
the first, second, and third sets of configuration bits stored in the first, second, and third sets of configuration registers determine configurations of the first DPE, the second DPE, and the memory circuit, respectively.

9. The IC device of claim 4, wherein the memory circuit further comprises:
a direct-memory access (DMA) engine configured to interface with a DMA engine of the first DPE via the first IO interface, and to interface with a DMA engine of the second DPE via the second IO interface.

10. The IC device of claim 1, further comprising:
a first set of data processing elements (DPEs) configured to access the memory bank via the first IO interface; and
a second set of DPEs configured to access the memory bank via the second IO interface;
wherein the synchronization circuitry is further configured to manage access to the memory bank by the first and second sets of DPEs.

11. An integrated circuit (IC) device, comprising:
a data processing array that comprises:
a memory circuit comprising a memory bank, a first input/output (IO) interface along a first edge of the memory circuit, a second IO interface along a second edge of the memory circuit, and synchronization circuitry configured to manage access to the memory bank via the first and second IO interfaces;
a first set of data processing elements (DPEs) configured to access the memory bank via the first IO interface; and
a second set of DPEs configured to access the memory bank via the second IO interface.

12. The IC device of claim 11, wherein:
the first set of DPEs is physically placed opposite the first edge of the memory circuit; and
the second set of DPEs is physically placed opposite the second edge of the memory circuit.

13. The IC device of claim 11, further comprising a data streaming network, wherein:
the first DPE comprises a first core, a first memory module, and a first stream switch of the data streaming network coupled to the first core and the first memory module;
the second DPE comprises a second core, a second memory module, and a second stream switch of the data streaming network coupled to the second core and the second memory module;
the first and second cores each comprise a processor and program memory configured to store instructions for execution by the processor; and
the memory circuit further comprises a third stream switch of the data streaming network configured to interface with the first stream switch via the first IO interface of the memory circuit, and to interface with the second stream switch via the second IO interface of the memory circuit.

14. The IC device of claim 11, further comprising a memory-mapped network, wherein:
the first DPE comprises a memory-mapped switch of the memory-mapped network configured to receive a first set of configuration bits, and a first set of configuration registers configured to store the first set of configuration bits;
the second DPE comprises a second memory-mapped switch of the memory-mapped network configured to receive a second set of configuration bits, and a second set of configuration registers configured to store the second set of configuration bits;
the memory circuit comprises a third memory-mapped switch of the memory-mapped network configured to receive a third set of configuration bits, and a third set of configuration registers configured to store the third set of configuration bits; and
the first, second, and third sets of configuration bits stored in the first, second, and third sets of configuration registers determine configurations of the first DPE, the second DPE, and the memory circuit, respectively.

15. The IC device of claim 11, wherein the memory circuit further comprises:
a direct-memory access (DMA) engine configured to interface with a DMA engine of the first DPE via the first IO interface, and to interface with a DMA engine of the second DPE via the second IO interface.

16. A graphics processing unit (GPU), comprising:
a GPU core; and
a data processing array configured to perform tasks for the GPU core, wherein the data processing array comprises:
a memory circuit comprising a memory bank, a first input/output (IO) interface along a first edge of the memory circuit, a second IO interface along a second edge of the memory circuit, and synchronization circuitry configured to manage access to the memory bank via the first and second IO interfaces;
a first set of data processing elements (DPEs) configured to access the memory bank via the first IO interface; and
a second set of DPEs configured to access the memory bank via the second IO interface.

17. The GPU of claim 16, wherein:
the first set of DPEs is physically placed opposite the first edge of the memory circuit; and
the second set of DPEs is physically placed opposite the second edge of the memory circuit.

18. The GPU of claim 16, further comprising a data streaming network, wherein:
the first DPE comprises a first core, a first memory module, and a first stream switch of the data streaming network coupled to the first core and the first memory module;
the second DPE comprises a second core, a second memory module, and a second stream switch of the data streaming network coupled to the second core and the second memory module;
the first and second cores each comprise a processor and program memory configured to store instructions for execution by the processor; and
the memory circuit further comprises a third stream switch of the data streaming network configured to interface with the first stream switch via the first IO interface of the memory circuit, and to interface with the second stream switch via the second IO interface of the memory circuit.

19. The GPU of claim 16, further comprising a memory-mapped network, wherein:
the first DPE comprises a memory-mapped switch of the memory-mapped network configured to receive a first set of configuration bits, and a first set of configuration registers configured to store the first set of configuration bits;
the second DPE comprises a second memory-mapped switch of the memory-mapped network configured to receive a second set of configuration bits, and a second set of configuration registers configured to store the second set of configuration bits;
the memory circuit comprises a third memory-mapped switch of the memory-mapped network configured to receive a third set of configuration bits, and a third set of configuration registers configured to store the third set of configuration bits; and
the first, second, and third sets of configuration bits stored in the first, second, and third sets of configuration registers determine configurations of the first DPE, the second DPE, and the memory circuit, respectively.

20. The GPU of claim 16, wherein the memory circuit further comprises:
a direct-memory access (DMA) engine configured to interface with a DMA engine of the first DPE via the first IO interface, and to interface with a DMA engine of the second DPE via the second IO interface.
